(19) United States
(12) Patent Application Publication
(10) Pub. No.: US 2013/0209946 A1
(43) Pub. Date: Aug. 15, 2013

(54) CANDLE WITH STONES

(71) Applicants: Sara O. George, Coral Gables, FL (US); Susan M. Isenberg, Miami, FL (US)

(72) Inventors: Sara O. George, Coral Gables, FL (US); Susan M. Isenberg, Miami, FL (US)

(73) Assignee: PETRA SOY CANDLE COMPANY LLC, Miami, FL (US)

(21) Appl. No.: 13/763,315

(22) Filed: Feb. 8, 2013

Related U.S. Application Data
(60) Provisional application No. 61/597,578, filed on Feb. 10, 2012.

(51) Int. Cl. C11C 5/00

(52) U.S. Cl. CPC C11C 5/002; C11C 5/008
USPC 431/289; 264/279

(57) ABSTRACT

Aspects of the present disclosure describe candles with one or more stones embedded into the fuel source. The fuel source may be a soy-based fuel. The soy-based fuel may also be scented. The one or more stones may be gemstones. The candle may be freestanding, or in a container. Additionally, a detachable bottom plate may be incorporated into the container that functions as a candle snuffer. Therapeutic qualities may be elicited by the combination of certain scents and gemstones. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This application claims the priority benefit of commonly owned, co-pending U.S. Provisional Patent Application No. 61/597,578, to Sara O. George and Susan M. Isenberg, filed Feb. 10, 2012, and entitled “SOY CANDLE WITH GEMS AND SCENTS” the entire disclosures of which are incorporated herein by reference.

### FIELD OF THE INVENTION

Embodiments of the present invention are directed to candles that are used for therapeutic purposes.

### BACKGROUND OF THE INVENTION

In addition to providing a source of light, candles are also used for therapeutic purposes. Through the use of different scents, the candle maker tries to create an essence that elicits a desired emotion or enhances a mental process. Such essences often try to elicit a calming or soothing state in the persons near the lit candle. These essences are released into the air through the burning of the candle. In order for a candle to burn an ignition source, such as a lighter or a match, melts a small amount of the wax in the candle. Through capillary action, the melted wax moves up towards the top of a wick. Once the liquefied wax moves up the wick, the heat from the ignition source vaporizes the wax. The vaporized wax combines with oxygen in the atmosphere to form a flame. At this point, the ignition source is no longer needed to keep the candle lit, because the flame produced from the vaporized wax and the oxygen produces enough heat to keep melting the wax and repeating the process.

Often, the wax used in candles is made from a petroleum based wax, like paraffin. Paraffin provides a fuel source that is stable and has a high melting temperature. However, the use of petroleum based waxes also has several drawbacks. First, the smoke generated from burning petroleum products contains many carcinogenic toxins and produces black soot. In addition to being detrimental to the health of the individuals using the candle, the soot has the potential to damage property by leaving stains when used repeatedly indoors. Second, the petroleum needed to generate paraffin wax is not a renewable resource and it is of a limited supply. Finally, the combustion of paraffin produces air pollution and is another contributor to global warming.

When used for therapeutic purposes a candle should only serve to increase the user's health and should never be a cause for medical problems. It is within this context that embodiments of the present invention arise.

### SUMMARY OF THE INVENTION

The current invention provides an improved candle. The candle generally includes a fuel source with a wick at least partially embedded in the fuel source. One or more stones are embedded into or are placed on the fuel source.

Problems inherent in using a petroleum-based wax for a fuel source may be remedied by using a soy-based wax. Additionally, to increase the therapeutic quality of the candle, gemstones may be incorporated into the wax along with the scented oils. To improve the therapeutic value of the candles, scents are paired with gemstones. These pairings, as described below, produce a positive emotional response in a person or persons around the candle.

### BRIEF DESCRIPTION OF THE DRAWINGS

FIG. 1 describes a cross-sectional view of a candle in accordance with an aspect of the present disclosure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

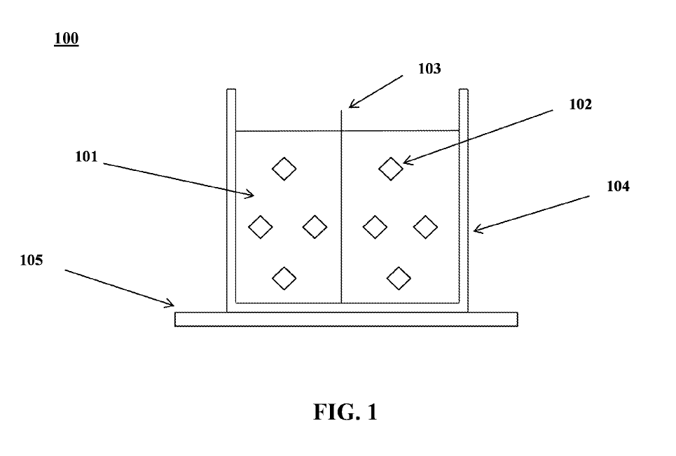

One possible embodiment of an improved therapeutic candle 100 is presented in FIG. 1. The figure shows fuel 101 being held by a container 104. Scattered throughout the fuel are one or more stones 102. A wick of the candle 103 may be positioned in the middle of the candle. An optional bottom plate 105 is detachable from the container 104 and can also be used as a snuffer.

The fuel 101 may be any suitable fuel used in candles. By way of example, and not by way of limitation, the fuel may be a soy-based wax. Soy-based wax provides advantages over petroleum-based waxes such as paraffin. Soy-based waxes burn cleaner than petroleum-based waxes. Without the additional soot present in the petroleum-based waxes there are fewer carcinogens present in the air. Since they burn cleaner, soy-based waxes also will not stain furniture or ceilings with extended indoor use. Another benefit of using a soy-based wax is that the candle will last longer. Soy-based wax has a lower melting temperature than that of paraffin wax and therefore will burn at a lower temperature and consume less wax.

The wax may be any commercially available soy wax, which is a hydrogenated form of soybean oil. In a preferred embodiment, the soy-based wax is made from 100% pure soybean oil with no added fillers or blends. This creates a soft wax that is prone to melting and a container 104 may be used to support the wax. The container 104 can be composed of any number of materials that provide adequate structural support for the wax. However, the need for a container 104 can be eliminated through the use of alternative compositions of the soy-based wax. By decreasing the amount of soy in the composition, an increase in the hardness and melting temperature of the soy-based wax 101 can be achieved. When the melting temperature is sufficiently increased through the use of alternative compositions, there will be no need for a container 104 to support the therapeutic candle. The wick 103 can be made from a variety of materials including, but not limited to cotton, hemp, or other synthetic fibers that are capable of wicking the melted wax upwards. The bottom plate 105 can be made from materials that are flame resistant. In a preferred embodiment, the bottom plate is made of a slice of agate that has been polished.

The stones 102 may be gemstones may be selected for therapeutic properties associated with gemstones. In addition a scent agent, such as a scent oil, that is mixed with the wax 101 of the candle. The scent agent may also be selected for therapeutic properties associated with the scent agent. In certain embodiments both the scent agent and gemstones may be paired based on their associated therapeutic properties. The scent and gemstone pairings include, but are not limited to the pairings listed in the table below. The gemstone and scent pairings can be disclosed to a customer through a label attached to the container 104 or packaged with the therapeutic candle in a different manner, including but not limited to packaging the candle in a box with the pairing described or attaching a tag to the candle describing the pairing. Examples of such pairings of gems and scents with desired properties and responses are described in Table I below.

TABLE I

| | | Desired Response |
|---|---|---|
| | | of burning |
| | | candle with scent and |
| Gemstone | Scent properties | gemstones |
| Amethyst | Infuse senses with tranquil | Relieve stress and promote |
| | and soothing thoughts, e.g., | introspection |
| | lavender | |
| Black | infuse senses with patience | Achieve goals and resolve |
| Moonstone | and help connect with nature, | problems |
| | e.g., gardenia | |
| Citrine | Infuse the senses with | Encouraging prosperity and |
| | positive energy, e.g., a citrus- | wealth |
| | based scent such as lemon, | |
| | lime, or orange | |
| Hematite | Infuse senses with | Diminish negativity and |
| | confidence and courage, e.g., | promote creative thought |
| | musk | |
| Jasper | Nurturing and grounding | Enhance quick-thinking and |
| | aroma, e.g., pine scent. | organizational abilities |
| Onyx | Infuse senses with emotional | Increasing stamina |
| | strength and self-control, | |
| | e.g., a floral aroma. | |
| Sardonyx | Invigorating and sweet | Promote love and give |
| | aroma that infuses senses | stability to partnerships |
| | with feelings of romance and | |
| | happiness, e.g., a floral scent. | |
| Sodalite | Infuse senses with feelings of | Promote self-confidence |
| | self-esteem and trust, e.g., a | and rational thoughts |
| | serene and tropical aroma, | |
| | such as coconut | |
| Tiger Eye | Infuse senses with clear | a grounding and energetic |
| | thoughts and logical | essence will be released |
| | thinking, e.g., vanilla. | into the environment. |
| | | This will bring about peace |
| | | and emotional balance. |

In order to incorporate the stones 102 into the candle, the soy based wax may be heated to the point that it softens or melts. The melted or softened wax may be poured into a container made of suitable material for a candle holder, such as glass. The gemstones may be mixed into the softened or melted wax either before or after the transfer to the container. A wick may be added to the container while the wax is still soft, either before or after the wax is transferred to the container. The stones 102 may be placed on top of the wax 101 in the container 104 after the wax has been poured into the container and the wick 103 has been inserted. After the candle is lit, the stones are immersed into the soy wax. At the end of the burn, the gemstones can be removed and washed and used for any other purpose.

It will be clear to one skilled in the art that the above-described embodiments may be altered in many ways without departing from the scope of the invention. While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC §112, ¶6.

What is claimed is:

1. A candle comprising:
a fuel source, wherein one or more stones are embedded into or are placed on the fuel source; and
a wick at least partially embedded in the fuel source.

2. The candle of claim 1, wherein the fuel source is a soy-based wax.

3. The candle of claim 2, wherein the soy-based wax is scented.

4. The candle of claim 3, wherein the one or more stones are gemstones.

5. The candle of claim 4, wherein the scent of the soy-based wax is lavender and the gemstone is amethyst.

6. The candle of claim 4, wherein the scent of the soy-based wax is gardenia and the gemstone is black moonstone.

7. The candle of claim 4, wherein the scent of the soy-based wax is a citrus-based scent and the gemstone is citrine.

8. The candle of claim 4, wherein the scent of the soy-based wax is musk and the gemstone is hematite.

9. The candle of claim 4, wherein the scent of the soy-based wax is pine and the gemstone is jasper.

10. The candle of claim 4, wherein the scent of the soy-based wax is a floral aroma and the gemstone is onyx.

11. The candle of claim 4, wherein the scent of the soy-based wax is floral scent and the gemstone is sardonyx.

12. The candle of claim 4, wherein the scent of the soy-based wax is a tropical aroma and the gemstone is sodalite.

13. The candle of claim 12, wherein the tropical aroma is coconut.

14. The candle of claim 4, wherein the scent of the soy-based wax is vanilla and the gemstone is tiger eye.

15. The candle of claim 1, wherein the candle is held by a container.

16. The candle of claim 15, further comprising a bottom plate.

17. The candle of claim 16, wherein the bottom plate configured to be a detachable candle snuffer.

18. The candle of claim 16, wherein the bottom plate is made of a slice of agate that has been polished.

19. The candle of claim 1, wherein the one or more stones are selected for therapeutic qualities associated with the one or more stones.

20. A method of making a candle, comprising:
melting a fuel source;
filling a container with the melted fuel source;
embedding one or more stones in the melted fuel source;
inserting a wick into the melted fuel source;
allowing the fuel source to solidify.
